(19) United States
(12) Patent Application Publication
(10) Pub. No.: US 2007/0144013 A1
(43) Pub. Date: Jun. 28, 2007

(54) Ergonomic hand tools

(76) Inventor: Takuya Ishida, Laguna Hills, CA (US)

Correspondence Address: CROCKETT & CROCKETT, 24012 CALLE DE LA PLATA, SUITE 400, LAGUNA HILLS, CA, 92653, US

(21) Appl. No.: 11/712,700

(22) Filed: Feb. 28, 2007

Related U.S. Application Data
(63) Continuation-in-part of application No. 11/303,823, filed on Dec. 15, 2005.

(51) Int. Cl. B26B 13/20

(52) U.S. Cl. 30/232; 30/341

(57) ABSTRACT

Ergonimic hand tools according to the present disclosure provides variations in finger relief to accommodate variations in human physiology and an aligning finger handle that aligns the users fingers into a minimum stress position relative to each other and to the thumb.

### RELATED APPLICATIONS

This application is a continuation-in-part of copending U.S. Utility Application Ser. No. 11/303,823 filed Dec. 15, 2005.

### FIELD OF THE INVENTIONS

The inventions described below relate the field of hand tools, and more specifically to the field of ergonomic hand tools with counter rotating or sliding elements for one-handed use.

### BACKGROUND OF THE INVENTIONS

Conventional cutting shears and other hand tools for one-handed use are generally one size fits all. This approach may be sufficient for most people who use hand tools, shears or scissors occasionally. The inexact fit of the tools or scissors with the shape and flexibility of the human hand causes limited problems.

Some portion of the population use hand tools, shears or scissors in their chosen line of work, and for these people, the lack of exact fit of shears to the human hand is causing serious physical injury. In the case of medical instruments poorly performing hand tools jeopardize not only the surgeons hands but also the patient's life.

What is needed is hand tools that are sized to provide a positive engagement with the human hand to minimize stress and thus repetitive motion injuries and to minimize tool slippage.

### SUMMARY

Ergonomic shears or other ergonomic hand tools according to the present disclosure includes an aligning finger handle that aligns the users fingers into a minimum stress position relative to each other and to the thumb.

In another aspect of the present disclosure ergonomic hand tools provides variations in finger relief to accommodate variations in human physiology.

In still another aspect of the present disclosure, the thumb handle of a hand tool is shortened to minimize the required movement to operate the tool and thus minimize stress on a users hand.

### BRIEF DESCRIPTION OF THE DRAWINGS

FIG. 1 is a side view of conventional shears.

FIG. 2 is a side view of closed ergonomic shears according to the present disclosure.

FIG. 3 is a side view of open ergonomic shears according to the present disclosure.

FIG. 4 is a side view of closed ergonomic shears according to the present disclosure overlaid on the conventional shear of FIG. 1.

FIG. 5 is a side view illustration of the geometry of the closed ergonomic shears of FIG. 2.

FIG. 6 is a side view of the ergonomic shears of FIG. 2 engaged by a user's hand.

FIG. 7 is a side view of the ergonomic shears of FIG. 2 in a standby position in a user's hand.

FIG. 8 is an alternate configuration of a pair of ergonomic shears according to the present disclosure.

FIG. 9 is an alternative ergonomic hand tool.

### DETAILED DESCRIPTION OF THE INVENTIONS

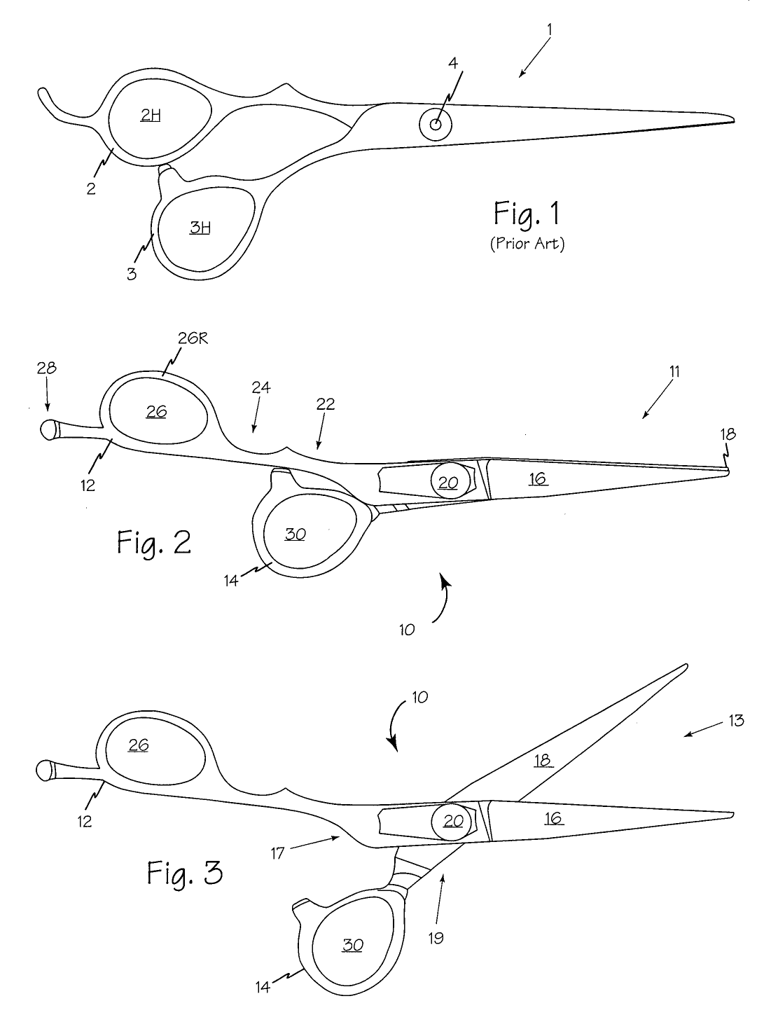

FIG. 1 illustrates conventional shears 1 with finger handle 2 and thumb handle 3 pivoting on pivot 4. The distances from finger hole 2H to pivot 4 is similar to the distance from thumb hole 3H to pivot 4. These distances provide mechanical advantage for cutting thick or heavy material.

FIG. 2 illustrates ergonomic scissors or shears 10 in primary or closed position 11, and FIG. 3 illustrates shear 10 in secondary or open position 13. Shears 10 include handles 12 and 14 connected to blades 16 and 18 respectively which pivot about pivot 20. Finger handle 12 includes finger positions 22, 24, 26 and 28. Third finger position 26 is enclosed by retainer 26R. Thumb handle 14 includes thumb hole 30. Shear 10 surrenders some mechanical advantage by shortening the distance from thumb hole 30 to pivot 20 compared to conventional devices. The benefits are improved ergonomic fit with human hands and minimized thumb movement by shortening the lever arm between the thumb hole and the pivot. Minimal thumb movement results in proportionally large movement of the tip of thumb blade 18.

Finger assembly 17 is formed by the combination of finger handle 12 with finger blade 16. Thumb assembly 19 is formed by the combination of thumb handle 14 with thumb blade 18.

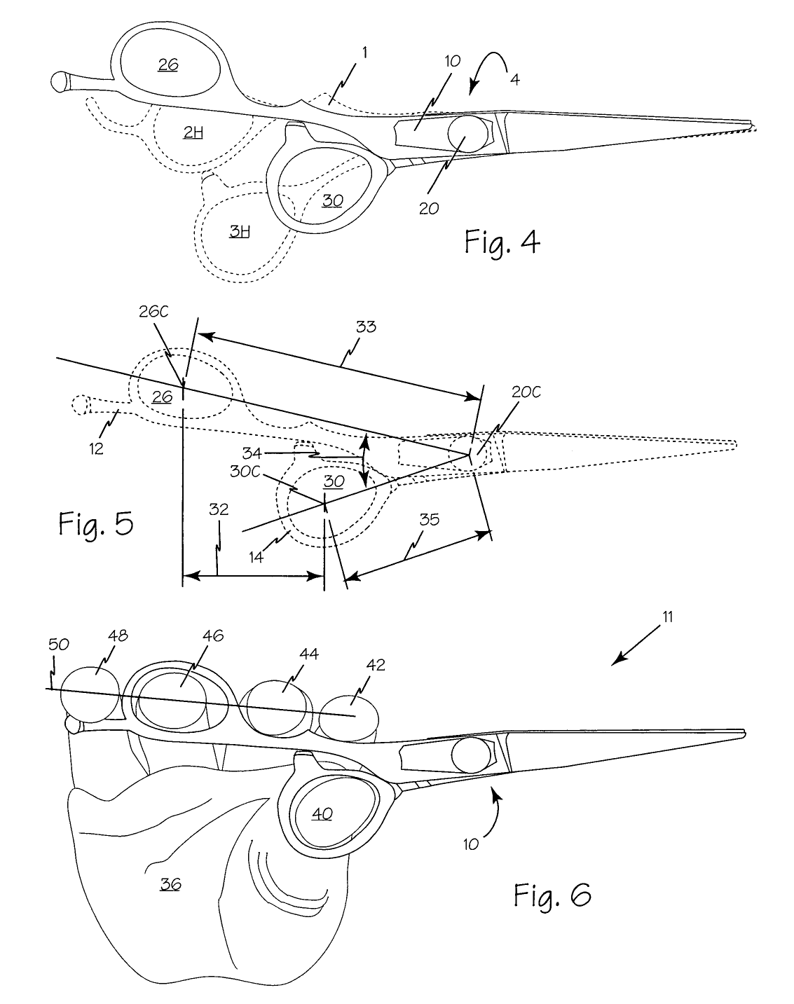

FIG. 4 illustrates a comparison between conventional shears 1 and ergonomic shears 10 with pivot 4 and pivot 20 aligned. Thumb hole 30 of shears 10 is closer to pivot 20 than thumb hole 3H is to pivot 4. Third finger position 26 is slightly farther from pivot 20 than finger hole 2H is from pivot 4. The alignment of third finger position 26 that enables finger positions 22, 24, 26 and 28 to be in a straight line is also illustrated.

Referring now to FIG. 5, ergonomic shears 10 may be produced in varying sizes and dimensions to minimize stress on a users hand. Finger relief distance 32 is determined in closed position 11 and may be from 1″ to 2¼″ to accommodate variations in human hand dimensions. Handle angle 34 is derived from a straight line from pivot center 20C through thumb hole center 30C and a straight line from pivot center 20C through third finger position center 26C with the shear in closed position 11. Any suitable handle angle 34 may be used with preferred handle angles between 12° and 48°.

Length 33 of finger handle 12 is generally determined by the distance from third finger position 26 to pivot 20. The length 35 of thumb handle 14 may be selected according the material to be cut by shears 10. Heavier material will necessitate lengthening thumb handle 14. Shears 10 as illustrated may be suitable for cutting hair or other relatively soft materials. Selection of length 35 to be between ⅓ and ⅔ of length 33 will enable suitable finger relief and produce an ergonomic benefit. The relatively short length 35 enables minimum movement of thumb handle 14 to cause greater movement of thumb blade 18. This advantage will require less movement of the thumb to cut hair, biologic tissue or other soft materials thus minimizing stress on a users hand.

Referring now to FIG. 6, selection of an appropriate finger relief distance 32 and corresponding handle angle 34 will permit user's hand 36 to engage shears 10 with fingers 42, 44, 46 and 48 aligned along straight line 50. In primary orientation 11, the alignment of fingers 42, 44, 46 and 48 minimizes stress on user's hand and fingers while maximizing a user's control over ergonomic shears 10.

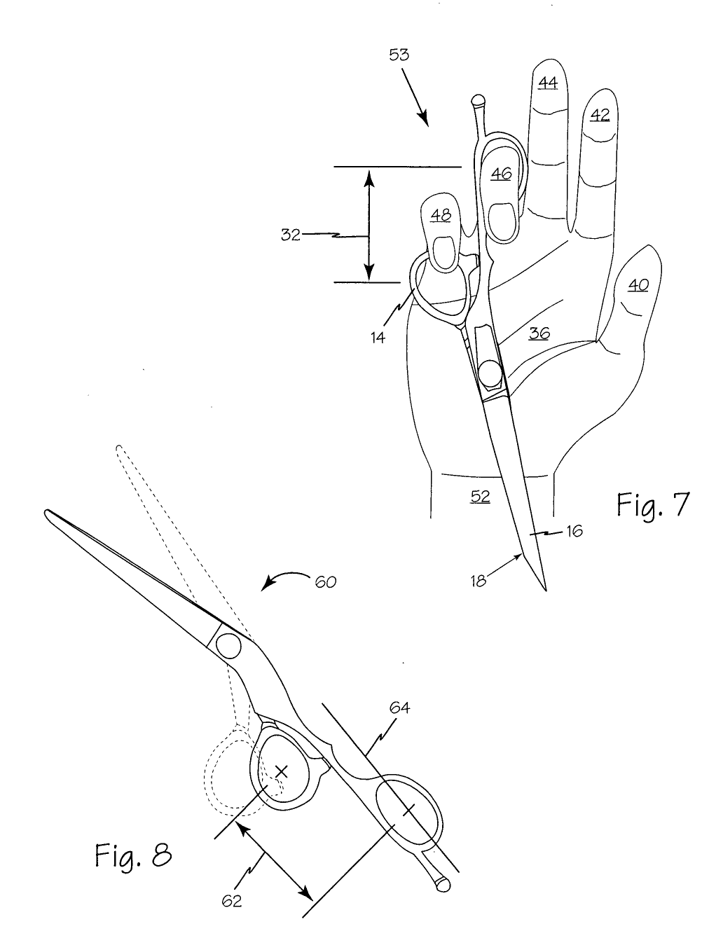

Referring now to FIG. 7, in use a user may permit ergonomic shears 10 to rotate about third finger position 26 allowing the small finger, fourth finger 48, to engage thumb handle 14 as shown. Finger relief distance 32 and the resulting angular separation of third finger position 26 and thumb hole 30 permits blades 16 and 18 to rest along a user's wrist 52. Standby orientation 53 frees user's fingers 42, 44 and thumb 40 to be used without the interference and danger posed by ergonomic shears 10.

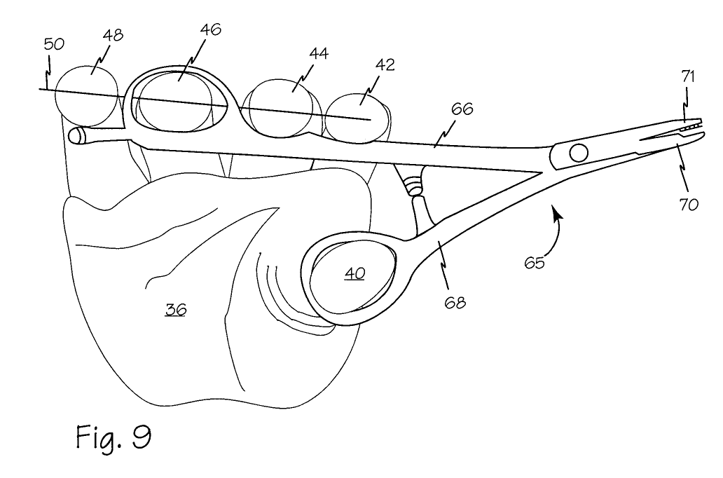

Similarly, a user may maintain ergonomic shears 10 or any other hand tool such as shears 60 of FIG. 8 or needle holder of FIG. 9 with similarly configured handles in it's use position as illustrated in FIG. 6 and fingers 42, 44 and the tip of thumb 40 may be used to manipulate biologic tissue, medical tools or accessories such as sutures without interference by the ergonomic tool such as ergonomic shears 10.

Alternatively, ergonomic shears according to the present disclosure may adopt any other suitable orientations such as illustrated in FIG. 8. Ergonomic shears 60 maintain a suitable finger relief distance 62 as well as a straight finger alignment 64.

Needle holder 65 of FIG. 9 includes finger handle 66 and thumb handle 68. Finger assembly 67 is formed by the combination of finger handle 66 with finger implement 70. Thumb assembly 69 is formed by the combination of thumb handle 68 with thumb implement 71. Thumb and finger implements may be any suitable implements motivated through a single or double pivot such a pliers, scissors, clamps, Kerrisons, cutters and diagonal cutters. This finger handle 66 and thumb handle 68 may also be applied to other surgical instruments that perform by sliding the operative elements such as Rongeurs.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. An ergonomic hand tool comprising:
a finger assembly including a finger handle joined to an operative finger element, the finger handle having a first, second, third and fourth finger position, the four finger positions aligned in a straight line with the first, second and fourth finger positions open;
a thumb assembly including a thumb handle joined to a thumb operative element, the thumb handle oriented to engage a user's thumb perpendicular to the thumb handle;
a pivot joining the finger assembly to the thumb assembly permitting counter rotation of the finger assembly and the thumb assembly about the pivot from a closed position to an open position and from the open position to the closed position.

2. The ergonomic tool of claim 1 wherein the third finger position further comprises a retainer encircling the third finger position, the retainer engaging a users third finger.

3. The ergonomic tool of claim 2 wherein the encircled third finger position includes a center and the thumb handle includes a thumb hole having a center, the distance from the center of the third finger position and the center of the thumb hole may be from 1 inch to 2¼ inches with the ergonomic tool in the closed position.

4. The ergonomic tool of claim 2 wherein the encircled third finger position includes a center and the thumb handle includes a thumb hole having a center, and an angle is formed between a line from the center of the third finger position to the pivot and a line from the center of the thumb hole to the pivot, the angle may be from 12° to 48° with the ergonomic tool in the closed position.

5. The ergonomic tool of claim 1 wherein the finger operative element comprises clamping means and the thumb operative element comprises clamping means.

6. The ergonomic tool of claim 1 wherein the finger operative element and the thumb operative element comprise diagonal cutters.

7. The ergonomic tool of claim 1 wherein the finger operative element and the thumb operative element comprise needle drivers.

8. The ergonomic tool of claim 1 wherein the finger operative element and the thumb operative element comprise needle holders.
